(19) United States
(12) Patent Application Publication
(10) Pub. No.: US 2006/0036464 A1
(43) Pub. Date: Feb. 16, 2006

(54) Method of Reducing Hypothetical Bias in Jury Studies

(76) Inventors: Daniel Robert Cahoy, State College, PA (US); Min Ding, State College, PA (US)

Correspondence Address: DANIEL ROBERT CAHOY, 662 FRANKLIN STREET, STATE COLLEGE, PA, 16803, US

(21) Appl. No.: 11/161,636

(22) Filed: Aug. 10, 2005

Related U.S. Application Data
(60) Provisional application No. 60/600,911, filed on Aug. 12, 2004.

(51) Int. Cl. G06Q 99/00

(52) U.S. Cl. 705/1; 705/80

(57) ABSTRACT

A method for reducing hypothetical bias in jury studies. The method utilizes an incentive-based approach to jury studies to help to reduce and/or remove hypothetical bias from these jury studies. The present invention uses an incentive that is to be awarded to an independent third person. This incentive is structured such that the closer the jury's decision comes to the correct result, the greater the amount of the incentive that is to be given to the independent third person. This structure is explained to the jury participating in the jury study such that the jury will desire to increase the amount of the incentive given to the independent third person. Accordingly, some of the previous issues of hypothetical bias, such as laziness, lack of attention to the evidence, and/or personal bias, are reduced or eliminated.

### CROSS REFERENCE TO RELATED APPLICATIONS

This application is a non-provisional application that claims priority of the provisional application for patent entitled “Method of Reducing Hypothetical Bias in Juries” filed Aug. 12, 2004 by the inventors Cahoy and Ding, U.S. Ser. No. 60/600911, currently pending.

### FEDERALLY SPONSORED RESEARCH

Not applicable

### SEQUENCE LISTING OR PROGRAM

Not applicable

### BACKGROUND OF THE INVENTION

1. Field of the Invention

The present invention relates to the field of legal services and, more particularly, to jury behavior.

2. Description of the Related Art

Juries are an essential part of the judicial system in the United States, with the responsibility for making important factual findings in variety of litigation contexts, from dramatic criminal prosecutions to mundane but complex civil trials. It is fair to say that United States juries, or more specifically “petit juries” or trial juries, present one of the most interesting and significant challenges for understanding human behavior. Juries have long been an integral part of justice in the United States, deciding not only guilt or innocence in dramatic criminal cases, but also making critical fact decisions in dry, but financially significant corporate cases. And with the apparent pervasiveness of litigation in our society, it is reasonable for anyone to consider the possibility of confronting six to twelve of their nominal “peers” sitting in judgment (though, few cases actually proceed to that point). But as prominent as is the position held by the American petit jury, it is also subject to concern, disparagement, and outright fear due to the general perception that juries are inherently subject to an unpredictable mingling of negative biases and other preconceptions. Whether this concern derives from the average juror's background, education level, socio-economic status, or the ability to decide emotional or complex questions without the grounding in law that guides the judgment of judges and lawyers, it is most certainly a real and persistent problem that many have sought to address.

Unfortunately, while the ability to lift the fog surrounding jury decision-making would be beneficial it is frustratingly hard to achieve. In general, efforts to succinctly identify the elements that affect jury verdicts have met with mixed success. To a great extent, this is a product of the investigative methods used. The literature is replete with both criticisms and defenses of existing studies, but very little in the way of any new ideas as to how to improve this body of work.

Specifically, there are three general areas of concern in regards to juries—the possibility of outright bias against one of the litigants; the likelihood that jurors will put in less than the appropriate amount of effort in understanding and deciding a case, particularly when the facts are complex and the trial is lengthy; and juror incompetence, especially when a case concerns intricate issues, such as in intellectual property infringement litigations, or abstract scientific facts, as often occurs in cases regarding medical malpractice torts.

If jury behavior could be reliably determined, there is at least a chance that the improper influence of bias, sloth or ineptitude may be countered and much of the ill effect of unpredictability would dissipate. In other words, while a biased jury is obviously not the ideal, if the litigants truly understood the impact of various biases, they could craft case presentations in response (or perhaps even confront jurors with their prejudices). Greater predictability could restore confidence in the system lost to the perception of jury randomness and undue risk. Additionally, if the bias is proven to be significantly severe and pervasive, it may lead to reform that improves the process. Therefore, research that penetrates and dissects jury deliberations may be beneficial not only to present day litigants, but also to the very future of the petit jury in the American judicial system. Unfortunately, historical quirks combined with traditional experimental design flaws tend to preclude a useful understanding, effectuating a virtual cloak around the jury decision-making process (and making any method of penetrating this closed world highly valuable).

The closed nature of jury deliberation prevents effective study of how human nature affects the process. Most jurisdictions have rules that prevent intrusion into the jury room. There are, of course, other methods to obtain information from actual jurors aside from spying on jury deliberations. For example, jury consulting firms may collect demographic information on the likely composition of a particular jury pool. To the extent that some juror inclinations may be predicted based on broad characteristics, such information is useful, but the picture is far from complete. Unfortunately, it is possible that the situation will grow even less clear in the future, as there is evidence that jurors are uncomfortable with even the limited level of information that is currently available, supporting legislation or rules to add further protections.

As such, it would be beneficial to provide a method for better understanding jury decision making as reducing jury unpredictability would likely enhance confidence in the system, and may increase the use of juries that has fallen in the past few years. Moreover, unpredictability must be addressed with accurate evidence of biases, lest jury reform be undertaken in response to a problem that does not exist. However, current methods of jury research have failed to provide a solution that accurately reflects these biases due primarily to their simulated nature.

For example, the most utilized method of jury analysis, the mock jury approach, entails the use of study participants as jurors in a hypothetical scenario that mimics many of the elements of an actual court proceeding. The obvious theory is that study participants will react similarly to a real jury if given the same choices in a similar context. Through the use these experiments, researchers gather information on the influence of specific biases or litigation techniques on the experimental jury's deliberations. The main advantage of using mock juries over the indirect-data experiments is that a more scientific approach may be undertaken; every element of the mock trial may be modified to test its affect and the actual decision-making process may be observed. One may separate and analyze, element by element, the factors that contribute to jury verdicts.

Nevertheless, mock jury approaches still suffer from several disadvantages in their accuracy. For example, to induce an accurate response from the participants, most mock jury experiments require a great deal of effort in attempting to replicate as much of the trial process as possible by using, inter alia, realistic trial settings, lawyer arguments and judicial instructions. It is generally assumed that such realism—or “verisimilitude”—produces more accurate results. The inverse assumption is that study participants may be less likely to provide accurate information in the context of a clearly hypothetical setting. The latter statement's presumption of inaccuracy stems in part from the notion that participants who know that the consequences of their decisions will not impact actual people or companies may make different choices. This failure to give a response in a laboratory setting that accurately reflects true jury decision-making may be referred to as a “hypothetical bias.”

Accordingly, for mock juries and other jury study contexts in which involve the use of subjects in hypothetical settings, it would be beneficial to provide a method for reducing and/or removing hypothetical bias to permit a better understanding of the thought processes of jurors.

### SUMMARY OF THE INVENTION

The present invention provides a method for reducing hypothetical bias in a jury study. The present invention utilizes a third party incentive-based approach to jury studies to help to reduce and/or remove hypothetical bias from these jury studies. The present invention uses an incentive that is to be awarded to an independent third person. This incentive is structured such that the closer the juror's decision comes to the correct or appropriate result, the greater the amount of the incentive that is to be given to the independent third person. As the juror will desire to increase the amount of the incentive given to the independent third person, some of the previous issues regarding hypothetical bias are reduced and/or eliminated.

Traditional economics—“microeconomics,” to be more specific—provides useful insight into human behavior by making assumptions regarding the desires of individuals and determining the outcome of interactions given a set of facts. The assumptions are often intuitive and most certainly play a role in real decision-making, such as the notion that individuals wish to achieve the best economic outcome for themselves. The present invention utilizes certain aspects of this theory, but instead provides an incentive-based process that does not reward the individuals participating in the study, thereby eliminating the chance that self interest may be a factor, but by rewarding an independent third person based upon the actions of the juror.

In particular, the present invention provides a method of reducing and/or removing hypothetical bias from jury studies by structuring an incentive to be given to an independent third person based upon the actions of the juror. The incentive may be monetary or any other incentive. Once the incentive has been selected, the structure of the incentive is explained to the juror. The incentive is selected such that the juror is more inclined to obtain what he or she believes to be the best answer for a particular legal situation. Due to the incentive, the juror may be more inclined to concentrate on the facts and work to obtain an answer than a juror in a purely hypothetical setting. Because the experimental third-party incentive replicates the type of incentives that a person experiences in the context of real trial, the responses of the experimental juror are likely to be much more predictive of real jury decision making. These more accurate results may be used in the study of a wide variety of aspects of jury decision making.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating one embodiment of a method of reducing hypothetical bias according to one embodiment of the present invention.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of.”

As described above, the primary hypothetical problem in a jury study is the lack of incentive to care about the two parties who are engaged in the fictional dispute. The effect of hypothetical bias is that study participants do not have strong incentives to spend the cognitive efforts required to identify an accurate or reasonable answer. Based on the literature in other contexts, there may be at least one of three major categories of specific cognitive failures that occurs in jury studies: (1) mock jurors may expend less mental effort than a real jury in determining an appropriate decision, (2) mock jurors may not gather enough relevant information to have the ability to make an appropriate decision even if the requisite effort were expended, due to a lack of attention paid to the hypothetical facts, and (3) individuals may behave differently in response to the personal satisfaction gained when their decision results in a socially desirable outcome, even if it has no direct personal impact, and no such satisfaction will be gained from a hypothetical study, i.e. bias.

The present invention attempts to alleviate and/or eliminate these problems in mock jury studies and other studies of jury behavior including, but not limited to, voir dire, mock juries, and shadow juries. As such, the present invention provides a method for reducing and/or eliminating hypothetical bias in a study of jury behavior. The method uses an incentive that is to be given to an independent third person based upon the actions of the jury. As used herein, an “independent third person” may be any individuals, group of individuals, charity, organization or other entity that the prospective jury would desire to benefit from the results of their decision. As used herein, an “incentive” may be any money, goods, services or combination thereof that would be beneficial for the independent third person to receive.

Not wishing to be bound by theory, the present invention utilizes incentives to reduce or eliminate hypothetical bias. In general, when presented with a task, a rational individual will generally evaluate the tradeoff between the benefit and cost of that task and make a decision so that his/her utility from performing (or not performing) this task may be maximized. As such, by providing an incentive that will be awarded to an independent third person based upon their effort, the methods of the present invention provide a positive reason for individuals to perform the task asked of them rather than having them not perform the task.

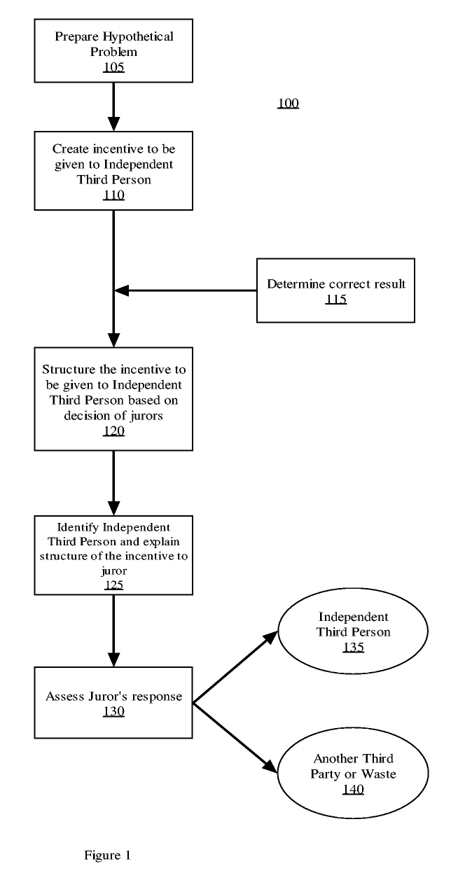

The incentive given to the independent third person is used in conjunction with a particular legal situation that is to be presented to an individual in a jury study. Accordingly, in one embodiment 1 00 of the present invention and as set forth in FIG. 1, prior to the jury study, a problem of interest for a particular legal situation is created in step 105. Then, in step 110, the incentive to be given to the independent third person is aligned with the juror's performance such that the closer the subject's performance moves toward that which is desired, the greater the amount of the incentive is to be presented to the independent third person.

In one embodiment of the present invention, one or more legal experts determine what the “correct” or “desired” result would be for that particular legal situation in step 115. Then, in step 120, this result may be used to structure the incentive to be given to the independent third person such that the closer to the correct result that the juror's answer comes, the greater the amount of the incentive that is then given to the independent third person.

After the hypothetical legal situation and the structure of the incentive have been created, the individual(s) in the jury study are then brought in. In step 125, the identity of the independent third person is identified to the individuals participating as well as the incentive that will be given to the independent third person. Additionally, the structure of the manner in which the amount of the incentive to be given will be determined will also be explained. Nevertheless, the correct or desired result is not explained to the individuals participating, thereby ensuring that the decision and deliberations are not influenced. While the structure of the incentive may vary from case to case, in general, the closer that the jury's decision comes to the predetermined result, the greater the amount of the incentive that is given to the independent third person. In one embodiment, the independent third person will be benefited only based on the jury's answer. In an alternative embodiment, the independent third person will be benefited, but the remainder of the incentive will be explicitly wasted or destroyed. As human nature generally does not view waste kindly, the individuals participating will be inclined to ensure that the independent third person receives the greatest amount of the incentive as possible.

In one embodiment, wherein the jury study is a mock trial, the study commences and the legal situation is set forth to the individuals participating. All of the evidence and other materials that are expected to be used at the actual trial may be used. Alternatively, only some evidence may be used to determine the effect of certain information on the jury. As there is an incentive for the individuals participating to arrive at the correct result, the method of the present invention contemplates that the individuals participating will concentrate on the evidence, even in those situations that may be confusing and/or complex, such as intellectual property litigation. As the individuals participating will desire to arrive at the correct result to benefit the independent third person, the problems with laziness, lack of attention to the evidence, and/or bias are reduced and/or eliminated.

The individuals participating in the study then deliberate. The deliberations may be observed for additional information regarding the information the individuals participating deemed most relevant. As the individuals participating have an incentive to come to the correct result, this information should be more beneficial. The individuals participating are then asked to render what they believe to be the correct result in step 130. At the conclusion of the study, the individuals participating may, in one embodiment, be told what the predetermined result was, the closeness of their answer to the predetermined result, the amount of the incentive to be given to the independent third person and/or the amount of the incentive that is given to another third party or wasted (135 and 140). Alternatively, in another embodiment, the individuals participating may simply be told how close they were to the predetermined result.

In another embodiment, the methods of the present invention may be used wherein the jury study may be a study for voir dire purposes. In this embodiment, one could run a study of subject responses to voir dire questions by individuals of given demographics. If one used participants in a hypothetical setting, the methods of the present invention may be used to apply actual independent third person consequences to responses obtained later in the experiment that would uncover real biases.

In still another embodiment, the methods of the present invention may be used wherein the jury study may be a shadow jury study. In this embodiment, one could run a traditional shadow jury, but tie their responses into independent third person consequences. This method may be operated in a similar manner as a mock jury.

In still another alternative embodiment, the independent third person may be selected as before, but another third party may also be selected wherein the incentive is structured in the same manner. In this embodiment, the amount of incentive given to the independent third person may the same or similar as in the previous embodiment, the remainder of the incentive is now given to the other third party. As such, presuming the independent third person is a more worthwhile recipient than the other third party, the jury will attempt to ensure the higher amount of the incentive goes to the independent third person. This may be especially true if the other third party is an unworthy recipient of the incentive.

In yet another embodiment, the methods of the present invention may utilize individual answers that are randomly chosen as the basis for awarding the incentive to the independent third person. In some instances, a person may decide to vote with a majority even though the answer chosen did not represent their answer simply to avoid a conflict. As such, by using individual answers rather than the group answer, this helps to ensure that each individual is participating rather than possibly being swayed by the group mentality.

Accordingly, the present invention uses an incentive-based mechanism to reduce or eliminate bias in a study involving jury behavior. While the field of jury studies for mock litigations has been discussed in greater detail, it is to be understood that the present invention is not limited to this area, but may include other areas of jury study including, but not limited to, shadow juries and voir dire of prospective jury members. In fact, the present invention may be applicable to any field in which the study of non-self interest in decision-making is important, such as public sector research. Accordingly, there are potentially many different ways to implement such a mechanism, but the following characteristics are generally included in the method of the present invention: it is beneficial for the mechanism to reflect social utility (or utility derived from rearranged welfare distribution among third parties) instead of personal utility; it is also beneficial for the mechanism to reward the effort of the jury in a similar manner as it would in a real jury context. Specifically, more effort should lead to higher social utility (as it becomes more accurate), but at a decreasing rate (concave).

The present invention will now be further described through examples. It is to be understood that these examples are non-limiting and are presented to provide a better understanding of various embodiments of the present invention.

### EXAMPLES

### Example 1

One possible embodiment of the incentive-aligned mechanism above could work as follows: An individual that nobody (neither the mock juror nor the researcher) has met before is recruited in real time (for example, randomly pulled from the street), and a well-respected charity is selected (for example, the Make-a-Wish® Foundation). The mock jurors are then told that a given amount of money (for example, $300) will be divided between the charity and the individual according to these steps:
(1) The individual will first receive a small amount (e.g., $20) for agreeing to participate in the study;
(2) All mock jurors are asked to make a decision on the case presented to them;
(3) The decision will be compared to a established “correct” decision (one that could be agreed upon by a legal experts, etc); and
(4) The remaining money (e.g., $280) will be given to charity if the mock jury reaches the same decision as the correct decision. On the other hand, the money that the charity receives will decrease (while the money received by the individual will increase) the more the mock jury's decision deviates from the standard decision. The decrease is proportional to the deviation.

Thus, using this mechanism, the mock juror is incentive-aligned to identify the standard decision to the best of their ability, because they derive positive utility for giving the money to charity while deriving negative utility for giving money to someone who simply receive a windfall due to simple luck (being chosen randomly). In other words, one would anticipate that the participants will attempt to avoid taking money away from the charity and giving it to a random individual by working harder, paying greater attention, etc.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method of reducing hypothetical bias in a study of jury behavior comprising:
Describing to at least one individual participating in a study of jury behavior an incentive structure involving an incentive that will be awarded to or removed from an independent third party in a manner that depends on said individual's responses to a request for information;
Providing said request for information to said individual; and
Obtaining said information from said individual.

2. The method of claim 1, wherein said individual is informed that his or her responses to said request for information will be compared to a correct or desired response.

3. The method according to claim 2, wherein said incentive is aligned with said individual's performance such that the closer said individual's performance moves toward said response which is desired or correct, the greater the amount of said incentive is to be presented to said independent third party.

4. The method according to claim 2, wherein said individual is informed that said correct or desired response will be determined by the response of one or more legal experts or an actual juror's response.

5. The method of claim 1, wherein said study comprises a mock jury deliberation.

6. The method of claim 1, wherein said study comprises subject responses to voir dire questions.

7. The method of claim 1, wherein said study comprises a shadow jury study.

8. The method of claim 1, wherein said incentive is divided between two independent third parties, one more desirable than the other.

9. The method of claim 1, wherein said incentive is divided between said independent third party and disposal in a wasteful manner.

10. The method of claim 1, wherein said study is realized in a centralized fashion in one computer system, or in a distributed fashion where different elements are spread across several interconnected computer systems, said systems utilizing a computer program that, when being loaded and executed, controls the computer system such that it carries out said methods.

11. A method of reducing hypothetical bias in a study of jury behavior comprising:
Preparing a hypothetical problem of interest for a particular legal situation;
Creating an incentive to be given to an independent third party;
Determining a correct or desired response to said hypothetical problem;
Assembling at least one individual to participate in a study of jury behavior;
Presenting said hypothetical problem to said individual;
Identifying said independent third party to said individual;
Explaining that said incentive will be awarded to said independent third party in an amount that depends on said individual's response to said hypothetical problem, with a greater amount being awarded the closer said individual's response is to said correct or desired response; and
Obtaining said individual's response to said hypothetical problem.

12. The method of claim 11, wherein said individual is informed that said correct or desired response will be determined by the response of one or more legal experts or an actual juror's response.

13. The method of claim 11, wherein said incentive is divided between two said independent third parties, one more desirable than the other.

14. The method of claim 11, wherein said incentive is divided between said independent third party and disposal in a wasteful manner.

15. The method of claim 11, wherein said study comprises a mock jury deliberation.

16. The method of claim 11, wherein said study comprises subject responses to voir dire questions.

17. The method of claim 11, wherein said study comprises shadow a jury study.

18. A computer program product for use in reducing hypothetical bias in a study of jury behavior comprising features that will accomplish the following steps:
Describing to at least one individual participating in a study of jury behavior an incentive that will be awarded to or removed from an independent third party in a manner that depends on said individual's responses to a request for information;
Providing said request for information to said individual; and
Obtaining said information from said individual.

19. The program product of claim 18, wherein said individual is informed that his or her responses to said request for information will be compared to a correct or desired response.

20. The program product of claim 19, wherein said incentive is aligned with said individual's performance such that the closer the subject's performance moves toward that which is desired or correct, the greater the amount of the incentive is to be presented to said independent third party.
